(19) United States
(12) Patent Application Publication
(10) Pub. No.: US 2005/0136787 A1
(43) Pub. Date: Jun. 23, 2005

(54) Method of forming carbon nanotube emitter and method of manufacturing field emission display using the same

(76) Inventors: Hang-Woo Lee, Suwon-si (KR); Shang-Hyeun Park, Boryeong-si (KR)

Correspondence Address: Robert E. Bushnell, Suite 300, 1522 K Street, N.W., Washington, DC, 20005, US

(21) Appl. No.: 11/002,184

(22) Filed: Dec. 3, 2004

(30) Foreign Application Priority Data
Dec. 4, 2003 (KR) 2003-87475

(51) Int. Cl. H01J 9/04; H01J 9/12

(52) U.S. Cl. 445/46

(57) ABSTRACT

A method for forming a carbon nanotube emitter by coating a photoresist on a substrate having an electrode already formed thereon, followed by patterning to form a photoresist dot on the electrode. The substrate is covered with a carbon nanotube paste that covers the photoresist dot. The carbon nanotube emitter is formed on the electrode by interdiffusion between the photoresist dot and the carbon nanotube paste through drying, and the carbon nanotube paste covering the carbon nanotube emitter is then removed.

### CLAIM OF PRIORITY

This application makes reference to, incorporates the same herein, and claims all benefits accruing under 35 U.S.C. §119 from an application for METHOD OF FORMING CARBON NANO TUBE EMITTER AND METHOD OF MANUFACTURING FIELD EMISSION DISPLAY USING THE SAME earlier filed in the Korean Intellectual Property Office on 4 Dec. 2003 and there duly assigned Serial No. 2003-87475.

### BACKGROUND OF THE INVENTION

1. Field of the Invention

The present invention relates to a method of forming a carbon nanotube emitter and a method of manufacturing a field emission display using the same. More particularly, the present invention relates to a method of forming a high purity carbon nanotube emitter using interdiffusion between a photoresist and a carbon nanotube and a method of manufacturing a field emission display using the same.

2. Description of the Related Art

Displays that illuminate varying visual images including text, are one of the main devices for information transmission media, and are conventionally used as PC monitors or television receivers. The displays can be largely classified as either cathode ray tubes (CRTs) using high-speed electrons emitted from a heated cathode and flat panel displays; both types of these displays have recently undergone very rapid improvement. Flat panel displays are divided into liquid crystal displays (LCDs), plasma display panels (PDPs), and field emission displays (FEDs).

FEDs are displays that emit light through the collision of phosphors of an anode with electrons emitted from field emitter arrays aligned on a cathode under the influence of a strong electric field created by a gate electrode.

Microtip emitters made of a metal such as molybdenum (Mo) were conventionally used as the field emitters for FEDs. More recently, carbon nanotube (CNT) emitters have mainly been used. CNT emitter-based FEDs have many advantages such as their wide viewing angle, high resolution, low power consumption, and temperature stability, and thus are especially suitable for use in various areas such as car navigation equipment and electronic viewfinders. In particular, CNT emitter-based FEDs can be used as alternative displays for personal computers, PDA (personal data assistant) terminals, medical equipment, HDTVs (high definition televisions), and the like. CNT emitters can also be used as field emitters for back lights of LCDs.

Such CNT emitters are generally formed by exposing a CNT paste to light in one of two manufacturing techniques. In one technique, known as a front-side method, a cathode, insulating layer that provides an emitter hole, and gate electrode that have been formed on a substrate are covered with a paste of a CNT, the CNT paste is selectively cured by exposing portions of the CNT paste to ultra-violet radiation irradiated toward the front side through a mask, and the unexposed CNT paste is removed. The exposed CNT paste which remains, is fired to form CNT emitters with a predetermined shape.

In the second technique, known as a back-side exposure method, an insulating layer providing an emitter hole and a gate electrode are formed upon a cathode, the insulating layer and gate electrode are coated with a layer of photoresist, and the photoresist and the exposed portions of the cathode are coated with a CNT paste which is selectively exposed to ultraviolet light radiated toward a back side of the substrate and the portion of the CNT paste that is radiated, and the photoresist, are removed, and the remaining CNT paste is fired to form CNT emitters with a predetermined shape.

These front-side and back-side techniques for making CNT emitters are based on the photosensitivity of a CNT paste, and thus, have limited ability to accommodate an increase in the content of CNTs. Furthermore, since a thick CNT paste film is used, the dose of a high energy (about 1,000 mJ or more) is required to expose the CNT paste. In addition, light scattering generated in a CNT paste during exposure renders the formation and alignment of the desired pattern difficult.

### SUMMARY OF THE INVENTION

The present invention provides a method of forming a high purity carbon nanotube emitter using interdiffusion between a photoresist and a carbon nanotube, and a method of manufacturing a field emission display using the same.

According to one aspect of the present invention, there is provided a method for forming a carbon nanotube emitter by coating a photoresist onto a substrate having an electrode thereon, followed by patterning to form a photoresist dot on the electrode. The substrate is coated with a carbon nanotube paste to cover the photoresist dot and a carbon nanotube emitter is formed on the electrode by interdiffusion between the photoresist dot and the carbon nanotube paste through drying. The carbon nanotube paste covering the carbon nanotube emitter is then removed.

The carbon nanotube emitter may be made of a mixture of the photoresist and the carbon nanotube paste.

The photoresist may be a positive photoresist.

The photoresist may use novolak as a base material and the carbon nanotube paste may use Texanol as a viscosity modifier.

The carbon nanotube emitter may be formed by interdiffusion between the novolak of the photoresist and the Texanol of the carbon nanotube paste. Here, the carbon nanotube emitter may be formed by diffusing the Texanol toward the carbon nanotube paste in order to dissolve the novolak and diffuse the dissolved novolak toward the carbon nanotube paste.

The drying may be performed by heating the carbon nanotube paste at approximately 80° C. for approximately 20 minutes.

The carbon nanotube paste covering the carbon nanotube emitter may be removed by development with a developer. The developer may be either acetone or a sodium carbonate (Na₂CO₃) solution.

According to another aspect of the present invention, there is provided a method for manufacturing a field emission display by forming sequentially a cathode, an insulating layer, and a gate electrode on a substrate, and forming an emitter hole to expose a portion of the cathode. The substrate is coated with photoresist and the photoresist is patterned to form a photoresist dot on the exposed portion of the cathode within the emitter hole. The substrate is coated with a carbon nanotube paste in order to cover the photoresist dot. A carbon nanotube emitter is formed on the cathode by interdiffusion between the photoresist dot and the carbon nanotube paste through drying. The carbon nanotube paste covering the carbon nanotube emitter is then removed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIGS. 1A through 1E are views in a sequence that illustrate one method for forming carbon nanotubes;

FIGS. 2A through 2E are views in a sequence that illustrate another method for forming carbon nanotubes;

FIGS. 3A through 3D are views in a sequence that illustrate a method of forming carbon nanotube emitters according to the principles of the present invention;

FIGS. 4A and 4B are, respectively, photographs of photoresist dots and carbon nanotube emitters formed on a substrate;

FIGS. 5A through 5E are views in a sequence that illustrate a method of manufacturing a field emission display according to the principles of the present invention;

FIG. 6 is a photograph of a screen of a field emission display using carbon nanotube emitters according to the principles of the present invention; and

FIG. 7 is a graph that illustrates the current-voltage characteristics of a field emission display using carbon nanotube emitters according to the principles of the present invention.

### DETAILED DESCRIPTION OF THE INVENTION

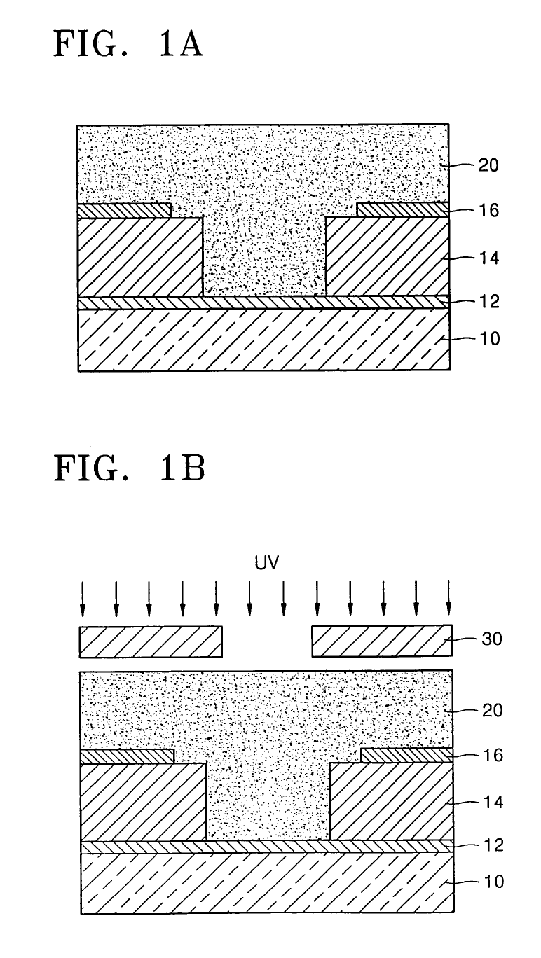

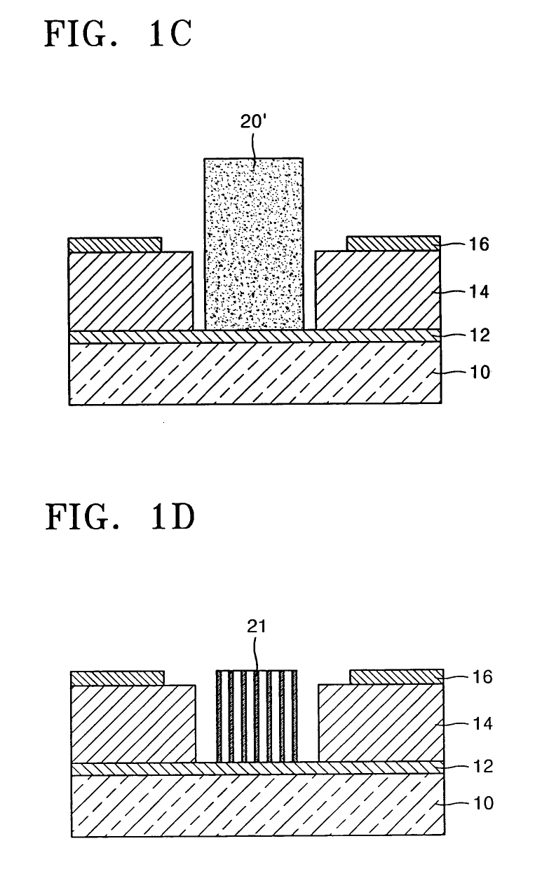

Turning now to the drawings, FIGS. 1A through 1E are views that illustrate a sequence in a method for forming CNT emitters for FEDs using a front-side exposure method in which a CNT paste is exposed to light.

First, referring to FIG. 1A, cathode 12, insulating layer 14 having an emitter hole, and gate electrode 16 are sequentially formed on substrate 10. CNT paste 20 is coated on the substrate 10 by a printing technique so as to cover cathode 12, insulating layer 14, and gate electrode 16. Then, a layer of CNT paste 20 is selectively exposed to ultraviolet (UV) light irradiated toward a front side of substrate 10 by using a mask 30, as is shown in FIG. 1B. At this time, an UV-exposed portion of CNT paste 20 is cured. Then, an unexposed portion of the CNT paste 20 is removed by using a developer such as acetone, as is shown in FIG. 1C. As a result, only an exposed CNT paste 20′ remains in the emitter hole. Then, exposed CNT paste 20′ shrinks by firing to form CNT emitters 21 with a predetermined shape, as shown in FIG. 1D. Finally, CNT emitters 21 are surface-treated with an adhesive tape so that pure CNTs 21 a are formed on the tips of CNT emitters 21, as is shown in FIG. 1E.

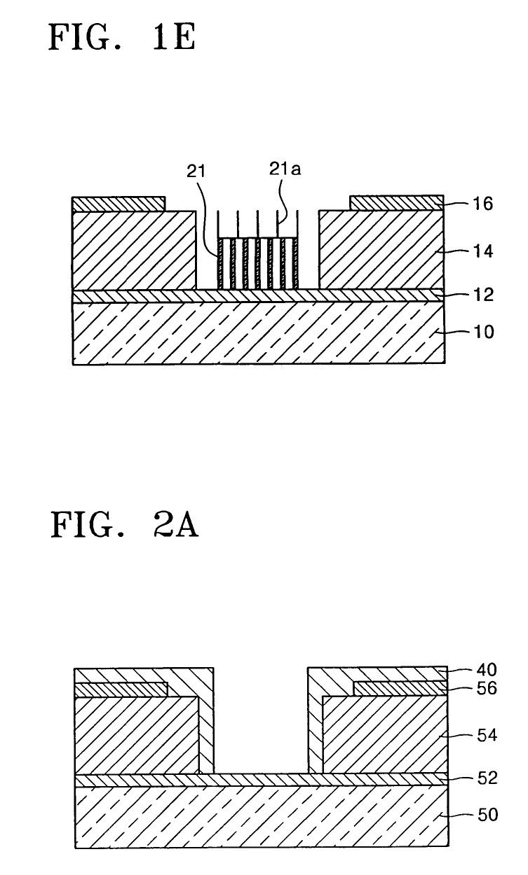

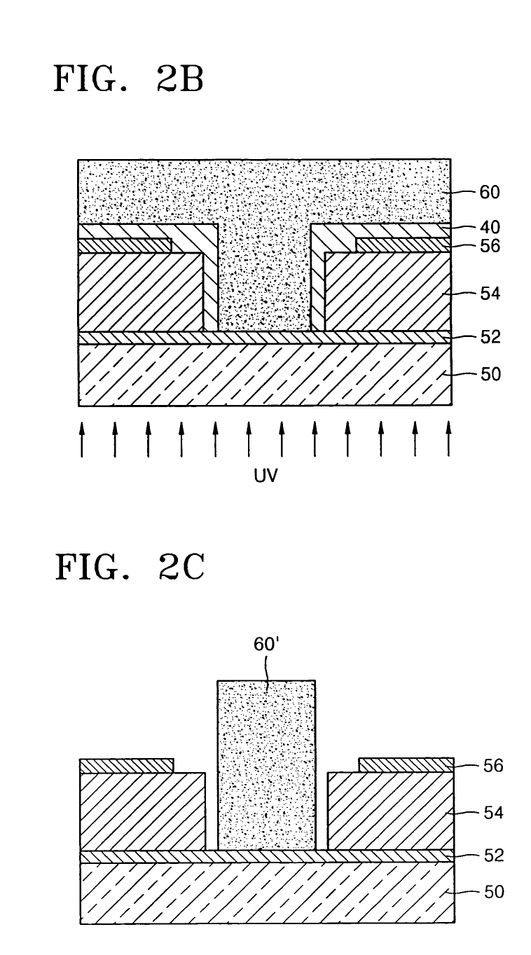

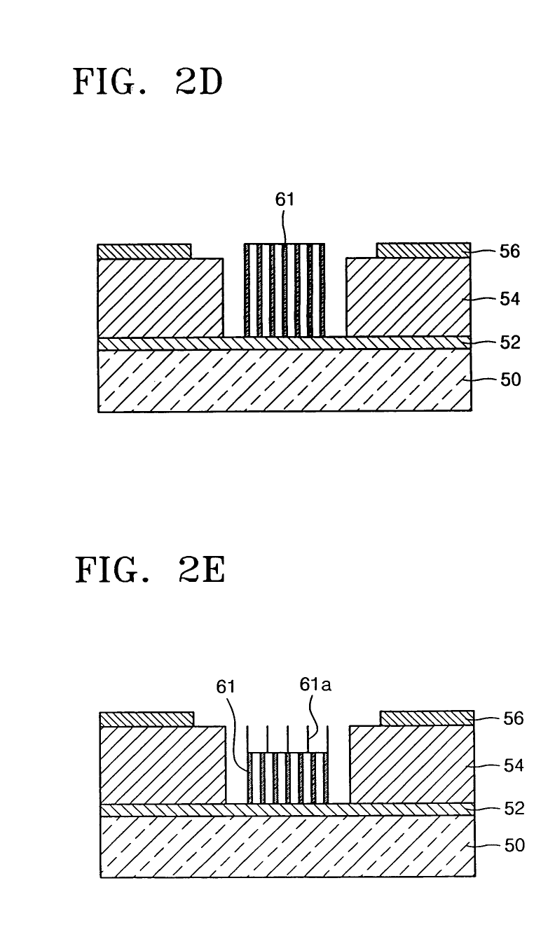

FIGS. 2A through 2E are views that illustrate a sequence in a method for forming CNT emitters for FEDs using a back-side exposure method.

First, referring to FIG. 2A, a cathode 52, an insulating layer 54 having an emitter hole, and a gate electrode 56 are sequentially formed on a substrate 50. A sacrificial layer 40 made of photoresist is coated on the substrate 50 so as to cover the cathode 52, insulating layer 54, and gate electrode 56 and insulating layer 54 is patterned to expose the portion of the cathode 52 within the emitter hole. Then, a CNT paste 60 is coated on the entire surface of the resultant structure of FIG. 2A by a printing method and is then selectively exposed to UV light irradiated toward a back side of substrate 50, as is shown in FIG. 2B. At this time, an UV-exposed portion of CNT paste 60 is cured. Then, an unexposed portion of CNT paste 60 is removed using a developer such as acetone and sacrificial layer 40 is removed, as is shown in FIG. 2C. As a result, only an exposed CNT paste 60′ remains in the emitter hole. Then, the exposed CNT paste 60′ shrinks by firing to form CNT emitters 61 with a predetermined shape, as is shown in FIG. 2D. Finally, the CNT emitters 61 are surface-treated with an adhesive tape so that pure CNTs 61 a are formed on the tips of the CNT emitters 61, as is shown in FIG. 2E.

Hereinafter, preferred embodiments of the present invention will be described in more detail with reference to the accompanying drawings. The same reference numerals indicate the same constitutional elements throughout the drawings.

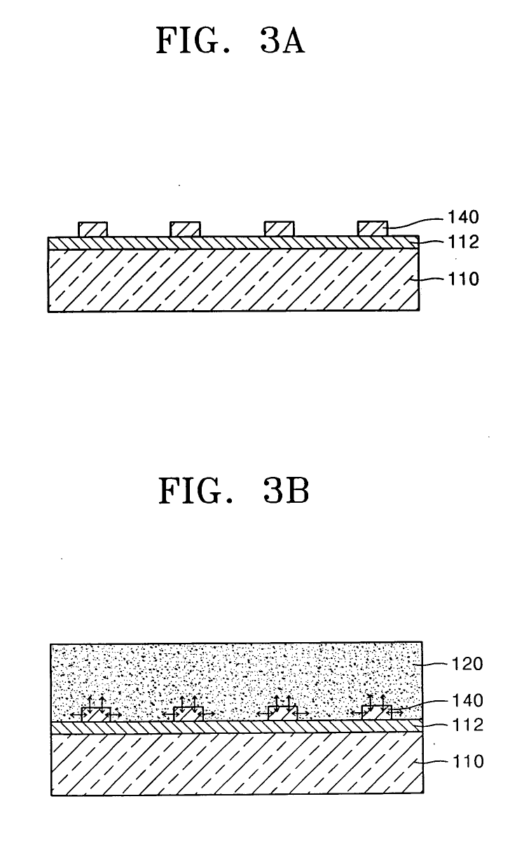

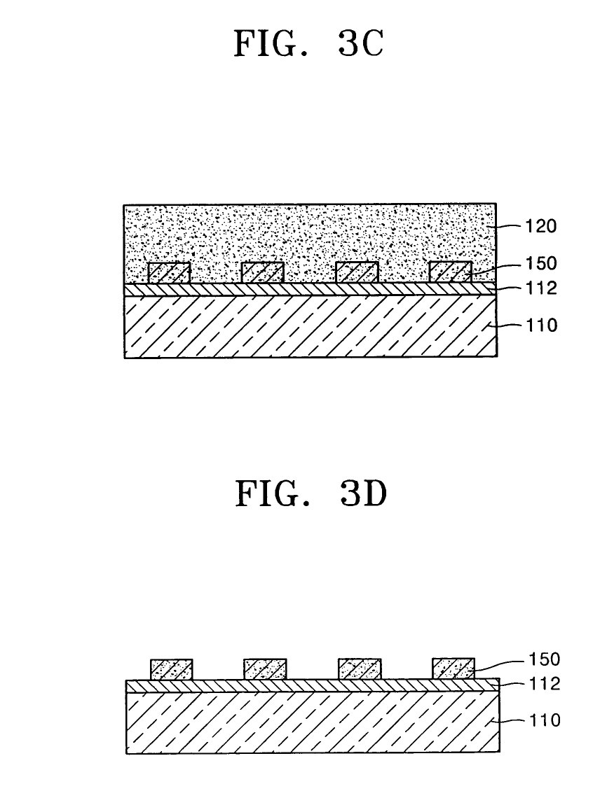

FIGS. 3A through 3D are views taken in a sequence that illustrate a method for forming carbon nanotube emitters constructed as an embodiment of the present invention.

First, a substrate 110 is prepared with an electrode 112 of a predetermined shape formed thereon. Substrate 110 is generally a glass substrate and the electrode 112 may be made of a transparent conductive material, such as ITO (indium thin oxide). Electrode 112 may be formed in a predetermined shape such as a striped shape on the surface of substrate 110.

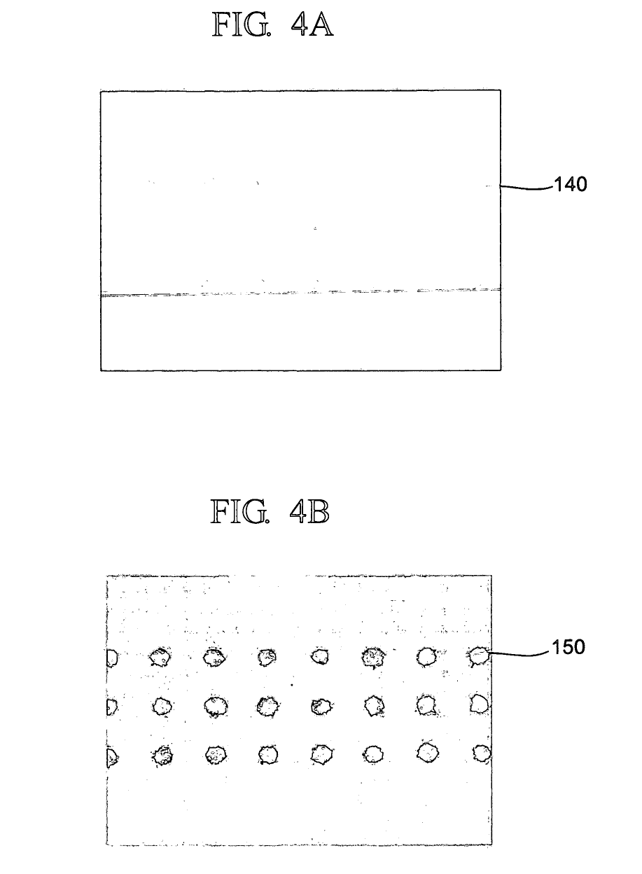

Next, photoresist dots 140 are formed on the exposed surface of electrode 112, as is shown in FIG. 3A. Photoresist dots 140 are formed by coating a layer of photoresist on substrate 110 having electrode 112 thereon followed by patterning. A photograph of photoresist dots 140 that have been formed on substrate 110 is shown in FIG. 4A. Preferably, the photoresist is a positive photoresist. The positive photoresist includes a sensitizer that is sensitive to light, a base material such as resin, and an organic solvent that dissolves the base material. In this embodiment, novolak is used as the base material. As is better explained in U.S. Pat. No. 5,139,925 for Surface Barrier Silylation Of Novolak File Without Photoactive Additive Patterned With 193 NM Excimer Laser by Mark A. Hartney, issued on the 18^{th} of Aug. 1992, as well as in other references, novolak resist is a cresol-formaldehyde copolymer, that in the practice of the instant exemplars, may be compounded with a photoactive component (i.e., a PAC).

Next, a carbon nanotube paste 120 is coated onto substrate 110 having electrode 112 and photoresist dots 140 formed thereon to cover photoresist dots 140, as is shown in FIG. 3B. Carbon nanotube paste 120 is generally coated by a printing method. In this embodiment, carbon nanotube paste 120 includes Texanol as a viscosity modifier. Texanol is a trademark of Eastman Chemical Co., located in Kingsport, Tenn.

Next, the carbon nanotube paste 120 is dried under a predetermined condition. For this, preferably, the carbon nanotube paste 120 is heated at about 80° C. for about 20 minutes. During the drying, interdiffusion between the photoresist dots 140 and the carbon nanotube paste 120 occurs, as is shown in FIG. 3B. In greater detail, first, the Texanol of carbon nanotube paste 120 diffuses toward photoresist dots 140 and then dissolves the novolak which is a component of the photoresist that forms photoresist dots 140. The novolak thus dissolved diffuses outwardly from photoresist dots 140 toward carbon nanotube paste 120.

Photoresist dots 140 are transformed to carbon nanotube emitters 150 made of a mixture of photoresist and carbon nanotube paste 120 by this interdiffusion, as is shown in FIG. 3C. At this time, carbon nanotube emitters 150 may be made to have a high purity by adjustment of the content of carbon nanotube paste 120.

Subsequently, carbon nanotube paste 120 covering carbon nanotube emitters 150 is removed by a developer so that only carbon nanotube emitters 150 remain on electrode 112, as is shown in FIG. 3D. The developer may be either acetone or a sodium carbonate (Na₂CO₃) solution. A photograph of carbon nanotube emitters 150 formed on substrate 110 is shown in FIG. 4B.

As described above, according to the present invention, carbon nanotube emitters 150 can be easily formed in a desired shape by using the interdiffusion between photoresist dots 140 and carbon nanotube paste 120, instead of by using an ultraviolet exposure method.

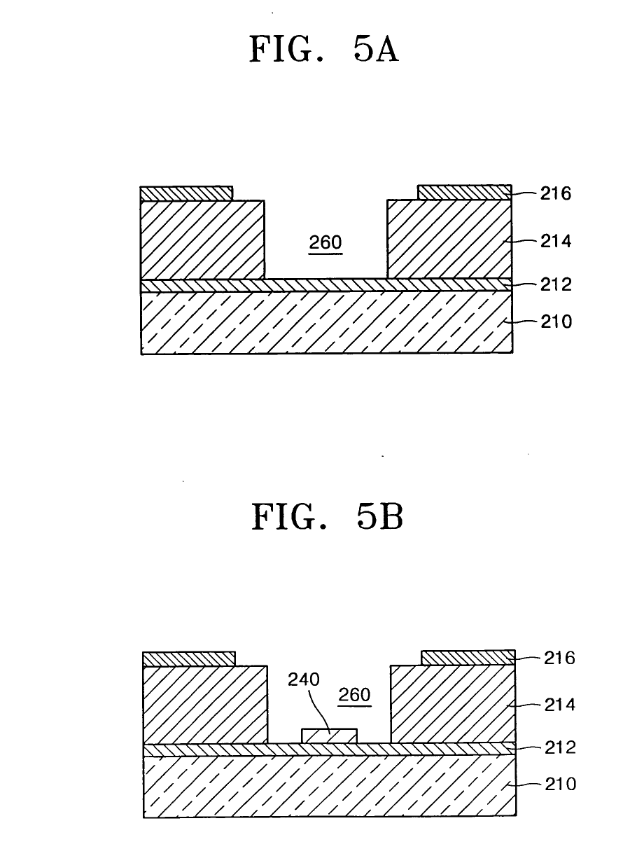

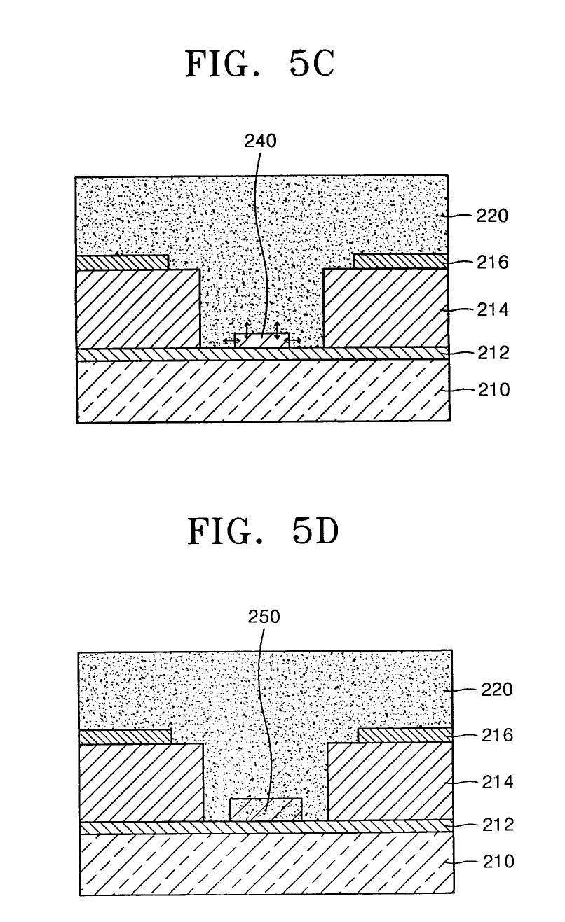

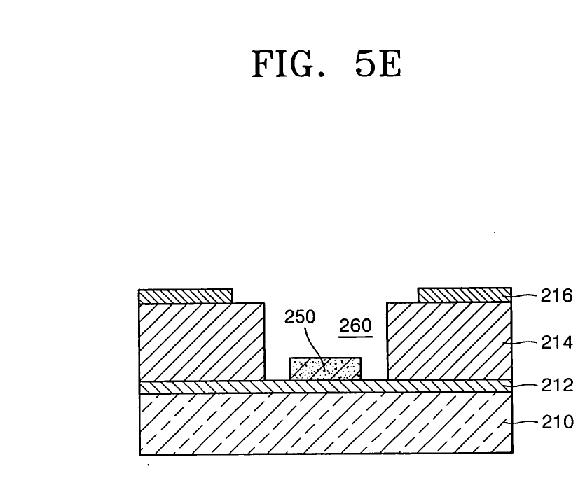

FIGS. 5A through 5E are views that illustrate a method for manufacturing a field emission display s another embodiment of the present invention.

First, cathode 212, insulating layer 214, and gate electrode 216 are sequentially formed on substrate 210 and emitter hole 260 intended for exposure of a portion of cathode 212, is then formed, as is shown in FIG. 5A. Substrate 210 may be a glass substrate. Cathode 212 may be made of a transparent conductive material such as ITO and gate electrode 216 may be made of a conductive metal such as chromium (Cr).

In grater detail, a cathode layer 212 made of ITO is deposited to a predetermined thickness on substrate 210 and then patterned to a predetermined shape, for example a striped shape, to form cathode 212. Insulating layer 214 is formed to a predetermined thickness on the entire surface of cathode 212 and substrate 210 and then a gate electrode layer is formed on insulating layer 214. Gate electrode layer 216 is formed by sputtering a conductive metal to a predetermined thickness and conductive metal is patterned to a predetermined shape to form gate electrode 216. Then, a portion of insulting layer 214 exposed through gate electrode 216 is etched to form emitter hole 260. At this time, a portion of cathode 212 is exposed through emitter hole 260.

Next, photoresist dot 240 is formed on the portion of cathode 212 exposed through emitter hole 260, as is shown in FIG. 5B. In detail, photoresist dot 240 is formed by coating a photoresist on the entire surface of the resultant structure of FIG. 5A, followed by patterning to provide the structure shown in FIG. 5B.

As mentioned earlier herein, a positive photoresist is preferable. The positive photoresist includes a novolak as a base material.

Next, carbon nanotube paste 220 is coated on the entire surface of the resultant structure of FIG. 5B to cover photoresist dot 240, as is shown in FIG. 5C. Carbon nanotube paste 220 may be coated by a printing method. As described above, carbon nanotube paste 220 includes texanol as a viscosity modifier.

Next, carbon nanotube paste 220 is dried under a predetermined condition. For this, preferably, carbon nanotube paste 220 is heated at about 80° C. for about 20 minutes. During the drying, interdiffusion between photoresist dot 240 and carbon nanotube paste 220 occurs, as is shown in FIG. 5C. Interdiffusion between photoresist dot 240 and carbon nanotube paste 220 is described in the above, and thus, a repetition of the detailed description thereof is omitted here.

Photoresist dot 240 is transformed to a carbon nanotube emitter 250 made of a mixture of the photoresist and carbon nanotube paste 220 through the interdiffusion, as is shown in FIG. 5D. At this time, carbon nanotube emitter 250 can have a high purity by adjustment of the content of carbon nanotube paste 220.

Finally, carbon nanotube paste 220 covering carbon nanotube emitter 250 is removed by a developer so that only carbon nanotube emitter 250 remains on cathode 212, as is shown in FIG. 5E. The developer may be either acetone or a sodium carbonate (Na₂CO₃) solution.

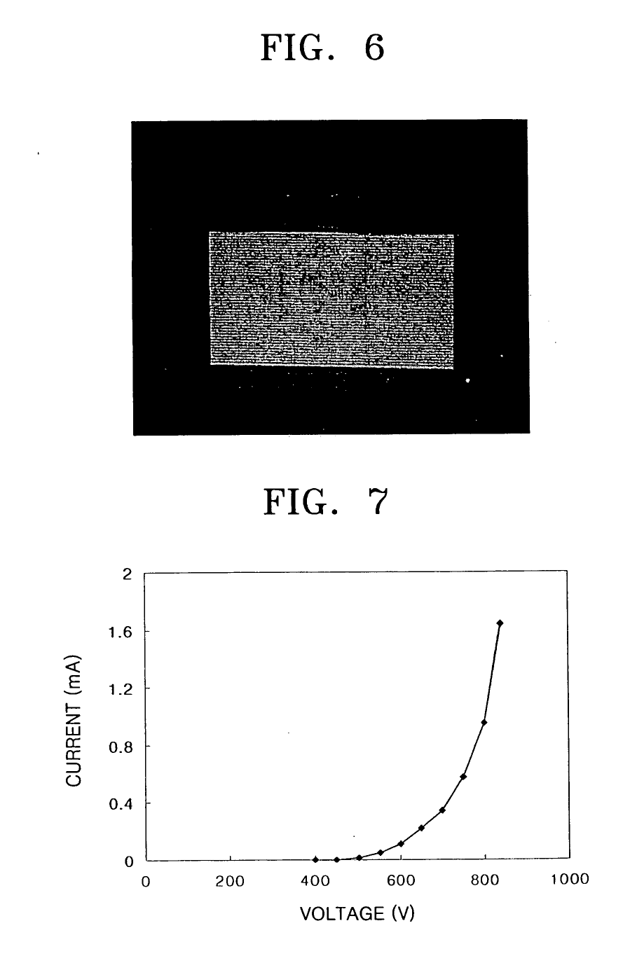

FIG. 6 is a photograph of a screen of a field emission display using carbon nanotube emitters formed according to the principles of the present invention. Referring to FIG. 6, it can be seen that the field emission display manufactured according to the present invention can provide the same image quality as a conventional field emission display.

FIG. 7 is a two-coordinate graph that illustrates the current-voltage characteristics of a field emission display manufactured according to the principles of the present invention. Referring to the graph of FIG. 7, the field emission display manufactured according to the present invention exhibits enhanced current (I)-voltage (V) characteristics, relative to a conventional field emission display. As is apparent from the above descriptions, the present invention provides the following advantages.

First, a carbon nanotube emitter can be formed in a desired shape by interdiffusion between a carbon nanotube paste and a photoresist. This technique for the formation of carbon nanotube emitters can be easily applied to the fabrication of a field emission display or to a back lit display.

Second, since the carbon nanotube emitter is formed without using one of the conventional exposure methods, there is no need to consider the light transmittance of the carbon nanotube paste. Therefore, the carbon nanotube emitter can be formed with a high purity by increasing the content of carbon nanotubes in the carbon nanotube paste.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of forming a carbon nanotube emitter, comprising:
coating with a photoresist a substrate and an electrode borne by the substrate;
patterning the photoresist to form a photoresist dot on the electrode;
coating the substrate with a carbon nanotube paste to cover the photoresist dot;
forming the carbon nanotube emitter on the electrode by interdiffusion between the photoresist dot and the carbon nanotube paste by drying the carbon nanotube paste; and
removing the carbon nanotube paste covering the carbon nanotube emitter.

2. The method of claim 1, comprised of making the carbon nanotube emitter of a mixture of the photoresist and the carbon nanotube paste.

3. The method of claim 1, wherein the photoresist is a positive photoresist.

4. The method of claim 1, wherein the photoresist comprises novolak as a base material.

5. The method of claim 4, wherein the carbon nanotube paste comprises Texanol as a viscosity modifier.

6. The method of claim 5, wherein the carbon nanotube emitter is formed by interdiffusion between the novolak of the photoresist and the Texanol of the carbon nanotube paste.

7. The method of claim 6, wherein the carbon nanotube emitter is formed by diffusing the Texanol toward the carbon nanotube paste to dissolve the novolak and diffusing the dissolved novolak toward the carbon nanotube paste.

8. The method of claim 1, wherein the drying is performed by heating the carbon nanotube paste at approximately 80° C. for approximately 20 minutes.

9. The method of claim 1, wherein the carbon nanotube paste covering the carbon nanotube emitter is removed by development with a developer.

10. The method of claim 9, wherein the developer is selected from among one of an acetone and a sodium carbonate (Na₂CO₃) solution.

11. A method of manufacturing a field emission display, comprising:
forming sequentially a cathode, an insulating layer, and a gate electrode on a substrate;
forming an emitter hole by exposing a portion of the cathode;
coating the substrate with a photoresist;
patterning the photoresist to form a photoresist dot on the exposed portion of the cathode within the emitter hole;
covering the photoresist dot by coating the substrate with a carbon nanotube paste;
forming a carbon nanotube emitter on the cathode by interdiffusion between the photoresist dot and the carbon nanotube paste by drying the carbon nanotube paste; and
removing the carbon nanotube paste covering the carbon nanotube emitter.

12. The method of claim 11, comprised of making the carbon nanotube emitter of a mixture of the photoresist and the carbon nanotube paste.

13. The method of claim 11, wherein the photoresist is a positive photoresist.

14. The method of claim 13, wherein the photoresist comprises novolak as a base material.

15. The method of claim 14, wherein the carbon nanotube paste comprises Texanol as a viscosity modifier.

16. The method of claim 15, wherein the carbon nanotube emitter is formed by interdiffusion between the novolak of the photoresist and the Texanol of the carbon nanotube paste.

17. The method of claim 16, wherein the carbon nanotube emitter is formed by diffusing the Texanol toward the carbon nanotube paste to dissolve the novolak and diffusing the dissolved novolak toward the carbon nanotube paste.

18. The method of claim 11, wherein the drying is performed by heating the carbon nanotube paste at approximately 80° C. for approximately 20 minutes.

19. The method of claim 11, wherein the carbon nanotube paste covering the carbon nanotube emitter is removed by development with a developer.

20. The method of claim 19, wherein the developer is selected from among one of an acetone and a Na₂CO₃ solution.
